(19) United States
(12) Patent Application Publication
(10) Pub. No.: US 2026/0071727 A1
(43) Pub. Date: Mar. 12, 2026

(54) LIGHTING APPARATUS

(71) Applicant: LEEDARSON LIGHTING CO.,LTD., Zhangzhou (CN)

(72) Inventors: Tangzhong LIU, Zhangzhou (CN); Hongkui JIANG, Zhangzhou (CN); Yuankai YOU, Zhangzhou (CN); Zhibin ZHENG, Zhangzhou (CN)

(21) Appl. No.: 19/317,069

(22) Filed: Sep. 2, 2025

(30) Foreign Application Priority Data
Sep. 11, 2024 (CN) 202422229194.4

(51) Int. Cl. F21K 9/238; F21K 9/235; F21V 23/04

(52) U.S. Cl. CPC F21K 9/238; F21K 9/235; F21V 23/0471

(57) ABSTRACT

An apparatus includes a bulb shell, a support structure, a light source, a touch sensor and a driver circuit. The support structure is disposed within the bulb shell. The light source includes a plurality of LED modules mounted on the support structure. The plurality of LED modules are configured to emit light having controllable parameters including at least one of color temperature or color by adjusting a mixing ratio among the plurality of LED modules. The touch sensor is disposed on the support structure and configured to detect a user touch event. The driver circuit is configured to receive a signal indicative of the user touch event from the touch sensor and, in response thereto, generate control signals to adjust the mixing ratio among the plurality of LED modules, thereby modifying at least one of the controllable parameters of the emitted light.

### FIELD

The present invention is related to a lighting apparatus, and more particularly related to a lighting apparatus with smart control.

### BACKGROUND

The field of lighting technology has experienced rapid development over the past several decades. In particular, the rise of light-emitting diode (LED) technology has fundamentally reshaped how illumination devices are designed and deployed in residential, commercial, and industrial environments. LEDs have steadily displaced traditional incandescent and fluorescent light sources due to their energy efficiency, longevity, and adaptability.

One of the primary drivers behind the fast adoption of LEDs is their ability to convert electrical energy into light with far greater efficiency than incandescent filaments or gas-discharge tubes. This efficiency translates directly into lower power consumption and reduced operating costs, which are key considerations for both consumers and large-scale facility operators.

Another reason LEDs have proliferated is their significantly extended operational life compared with traditional lamps. While incandescent bulbs may last for around one thousand hours, LED devices can often achieve tens of thousands of hours of service, thereby reducing replacement frequency and maintenance demands. This durability has made LEDs highly attractive in applications where accessibility is limited or replacement is costly.

The compact size of LED chips has also fueled design innovation in lighting products. Unlike bulky fluorescent tubes or fragile glass bulbs, LEDs can be integrated into small enclosures, flexible strips, or unconventional form factors. This allows designers to create lighting devices that are not only functional but also aesthetically pleasing and adaptable to architectural or decorative needs.

The ability of LEDs to produce light across a wide spectrum of colors without filters has further expanded their application space. By combining different semiconductor materials or using phosphor coatings, LEDs can generate warm white, cool white, or even tunable color temperatures, enabling more precise control over ambience and visual comfort.

Alongside these technical benefits, LEDs have been incorporated into lighting systems with increasing levels of control sophistication. Early implementations often relied on simple on-off switching, but modern systems may include dimming, color adjustment, and integration with digital or wireless controllers. As lighting has become smarter, the importance of effective user control has become equally significant.

Traditional methods of light control remain widespread. The most common is the wall switch, typically installed on a building’s wiring system and used to manually connect or disconnect power to the lighting circuit. This approach is familiar, reliable, and inexpensive, but it lacks flexibility once installed, as the switch position is fixed and its wiring predetermined.

Some lighting devices integrate manual switches directly into the lamp body or base. These switches may be toggles, push buttons, or rotary knobs that allow a user to operate the light without reliance on a wall-mounted fixture. Such switches provide convenience in portable lamps or task lights, but they can be less convenient when the device is installed in an overhead location or otherwise difficult to reach.

Other systems incorporate remote control technologies, whether infrared, radio frequency, or network-based, to allow operation from a distance. While these systems provide significant convenience, they introduce added complexity, require additional components, and may be prone to interference or failure if the controlling device is misplaced or its power source is depleted.

Touch-sensitive controls have also emerged, particularly in desk lamps or decorative fixtures. By responding to skin contact rather than mechanical actuation, such controls offer sleek appearance and minimal moving parts. However, they can be overly sensitive, leading to accidental activation, and may not function reliably in all environmental conditions.

Smart lighting solutions extend control even further by integrating with mobile applications, home automation hubs, or voice assistants. These systems allow scheduling, grouping, and dynamic adjustment of lighting characteristics. While technologically advanced, they depend on network connectivity and software maintenance, which may be intimidating for some users or introduce vulnerabilities.

Each of these control methods therefore carries distinct advantages and disadvantages. Wall switches are robust but inflexible, integrated switches are convenient but sometimes inconveniently located, remote controls add flexibility but also reliance on external devices, and smart systems offer versatility at the expense of complexity.

In addition, the diversity of LED lamp designs, including compact bulbs, strip lights, and embedded fixtures, means that not all control methods can be applied uniformly. For example, the limited space available in a compact LED bulb may not accommodate traditional switches, while large fixtures may not justify sophisticated network control.

Consequently, there exists a need for more adaptable, user-friendly methods of controlling lighting devices. Such methods should accommodate the compact size and unique requirements of modern LED bulbs and fixtures, while balancing convenience, cost, and reliability.

Therefore, it is beneficial if a better way to control light devices, for example for a light bulb, which has a smaller size and may require different settings to better control the device.

### SUMMARY

In some embodiments, a apparatus includes a bulb shell, a support structure, a light source, a touch sensor and a driver circuit.

The support structure is disposed within the bulb shell.

The light source includes a plurality of LED modules mounted on the support structure. The plurality of LED modules are configured to emit light having controllable parameters including at least one of color temperature or color by adjusting a mixing ratio among the plurality of LED modules.

The touch sensor is disposed on the support structure and configured to detect a user touch event.

The driver circuit is operatively coupled to the touch sensor and the plurality of LED modules, the driver circuit configured to receive a signal indicative of the user touch event from the touch sensor and, in response thereto, generate control signals to adjust the mixing ratio among the plurality of LED modules, thereby modifying at least one of the controllable parameters of the emitted light.

In some embodiments, the support structure includes a protruding column.

In some embodiments, the touch sensor is disposed on a top of the protruding column.

In some embodiments, the support structure includes a flexible bending light strip.

In some embodiments, the apparatus may also include a protruding column supporting the flexible bending light strip.

The touch sensor is disposed on the protruding column.

In some embodiments, the touch sensor is integrated with the flexible bending light strip.

In some embodiments, a control signal from the touch sensor is transmitted to the driver circuit via a conductive path disposed on the flexible bending light strip.

In some embodiments, the apparatus may also include at least one additional touch sensor.

The touch sensor and the at least one additional touch sensor are configured to detect touch events on different portions of the bulb shell.

In some embodiments, the controllable parameters include color temperature.

In some embodiments, the controllable parameters include color.

In some embodiments, the user touch event is associated with a mode change of the light source.

In some embodiments, the mode change switches among multiple modes, each mode having predetermined settings for controlling the plurality of LED modules.

In some embodiments, the mode change is associated with an operating schedule that varies the emitted light according to an internal clock.

In some embodiments, the touch sensor includes a light sensor with a filter configured to detect a specific wavelength of control light.

In some embodiments, the touch sensor includes an infrared (IR) sensor configured to detect an IR remote control signal.

In some embodiments, the touch sensor includes a light sensor configured to detect motion on the bulb shell.

In some embodiments, the touch sensor is configured to detect static electricity variation on the bulb shell to determine the user touch event.

In some embodiments, the apparatus may also include an Edison cap configured to couple to an Edison socket.

The light source and the support structure are enclosed in a top space defined by the bulb shell and the Edison cap.

In some embodiments, the apparatus may also include an electrode structure for guiding input power from the Edison cap to the plurality of LED modules.

A first part of the electrode structure is in the top space and a second part of the electrode structure is enclosed within the Edison cap.

In some embodiments, multiple types of touch sensing circuits are disposed in the light bulb.

Different touch patterns or timings during the user touch event trigger different control signals from the driver circuit.

### BRIEF DESCRIPTION OF DRAWINGS

FIG. 1 illustrates a structural schematic diagram of a touch lamp provided in an embodiment.

FIG. 2 illustrates a circuit structural schematic diagram of a touch lamp provided in an embodiment.

FIG. 3 illustrates a circuit structural schematic diagram of a driving component provided in an embodiment.

FIG. 4 illustrates a circuit structural schematic diagram of a constant-current driving module provided in an embodiment.

FIG. 5 illustrates a circuit principle diagram of a constant-current driving module provided in an embodiment.

FIG. 6 illustrates a circuit principle diagram of a main control module provided in an embodiment.

FIG. 7 illustrates a circuit principle diagram of an auxiliary power supply module provided in an embodiment.

FIG. 8 shows another light bulb example.

FIG. 9 shows a flexible light strip example.

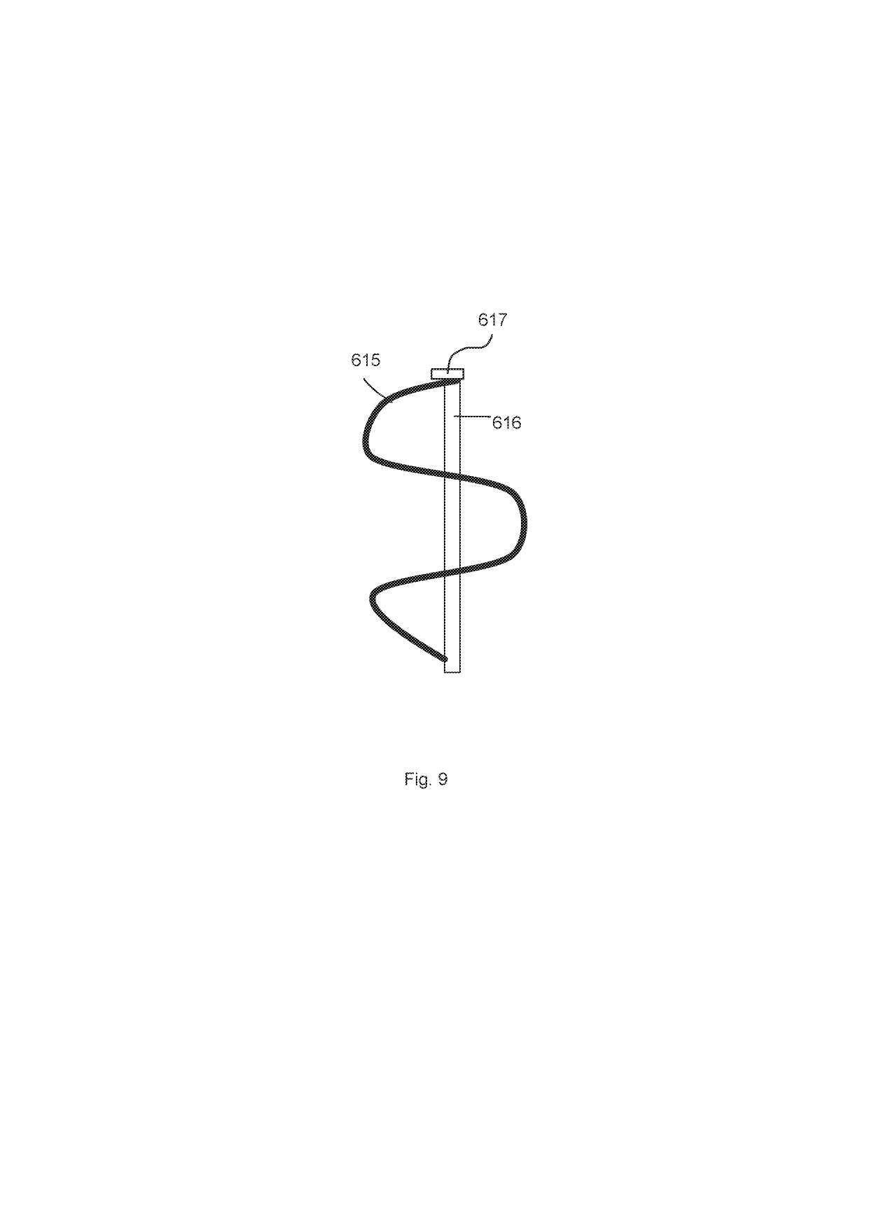

FIG. 10 shows disposing touch sensor on a flexible light strip.

### DETAILED DESCRIPTION

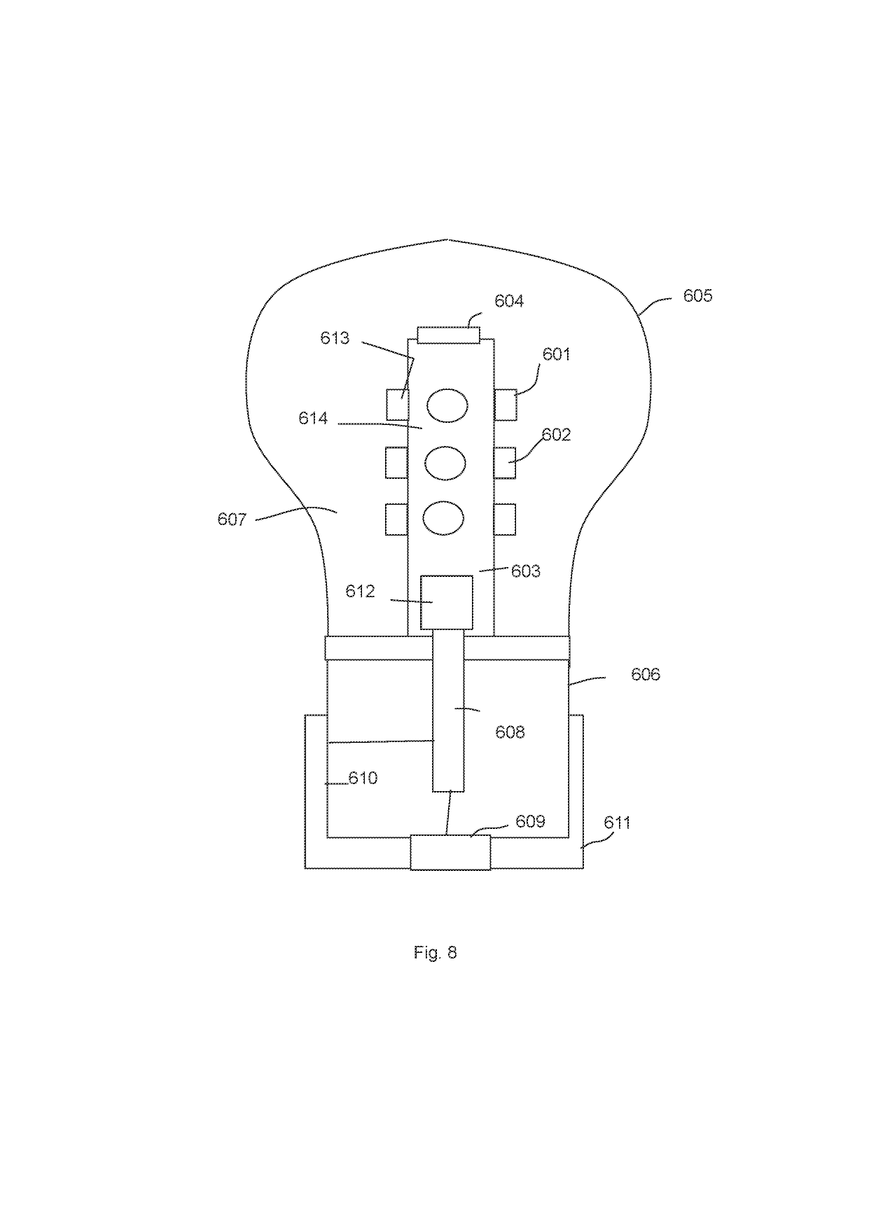

In FIG. 8, an apparatus, e.g. a light bulb, includes a bulb shell 605, a support structure 603, a light source 613, a touch sensor 604 and a driver circuit 612. The support structure 603 is disposed within the bulb shell 605.

The light source 613 includes a plurality of LED modules 601, 602 mounted on the support structure 603. The plurality of LED modules 601, 602 are configured to emit light having controllable parameters including at least one of color temperature or color by adjusting a mixing ratio among the plurality of LED modules 601, 602.

The touch sensor 604 is disposed on the support structure 603 and configured to detect a user touch event.

The driver circuit 612 is operatively coupled to the touch sensor 604 and the plurality of LED modules 601, 60. The driver circuit 612 is configured to receive a signal indicative of the user touch event from the touch sensor and, in response thereto, generate control signals to adjust the mixing ratio among the plurality of LED modules 601, 602, thereby modifying at least one of the controllable parameters of the emitted light.

In some embodiments, the support structure 603 includes a protruding column 614, as illustrated in FIG. 8

In some embodiments, the touch sensor 604 is disposed on a top of the protruding column 614.

In some embodiments, the support structure includes a flexible bending light strip.

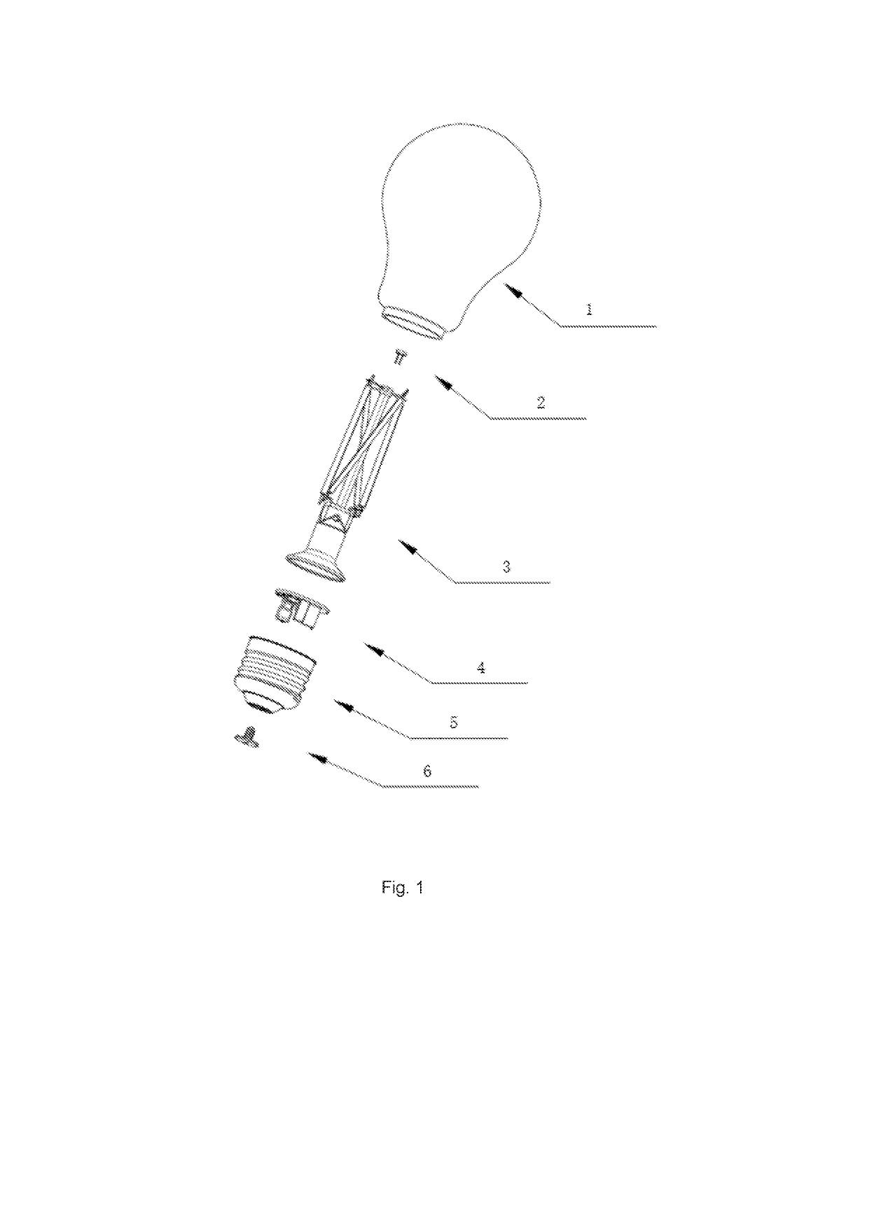

FIG. 1 shows an embodiment of multiple light strips that are rigid.

In FIG. 8, the apparatus may also include a protruding column 616 supporting the flexible bending light strip 615.

The touch sensor 617 is disposed on the protruding column 616.

In some embodiments, the touch sensor is integrated with the flexible bending light strip.

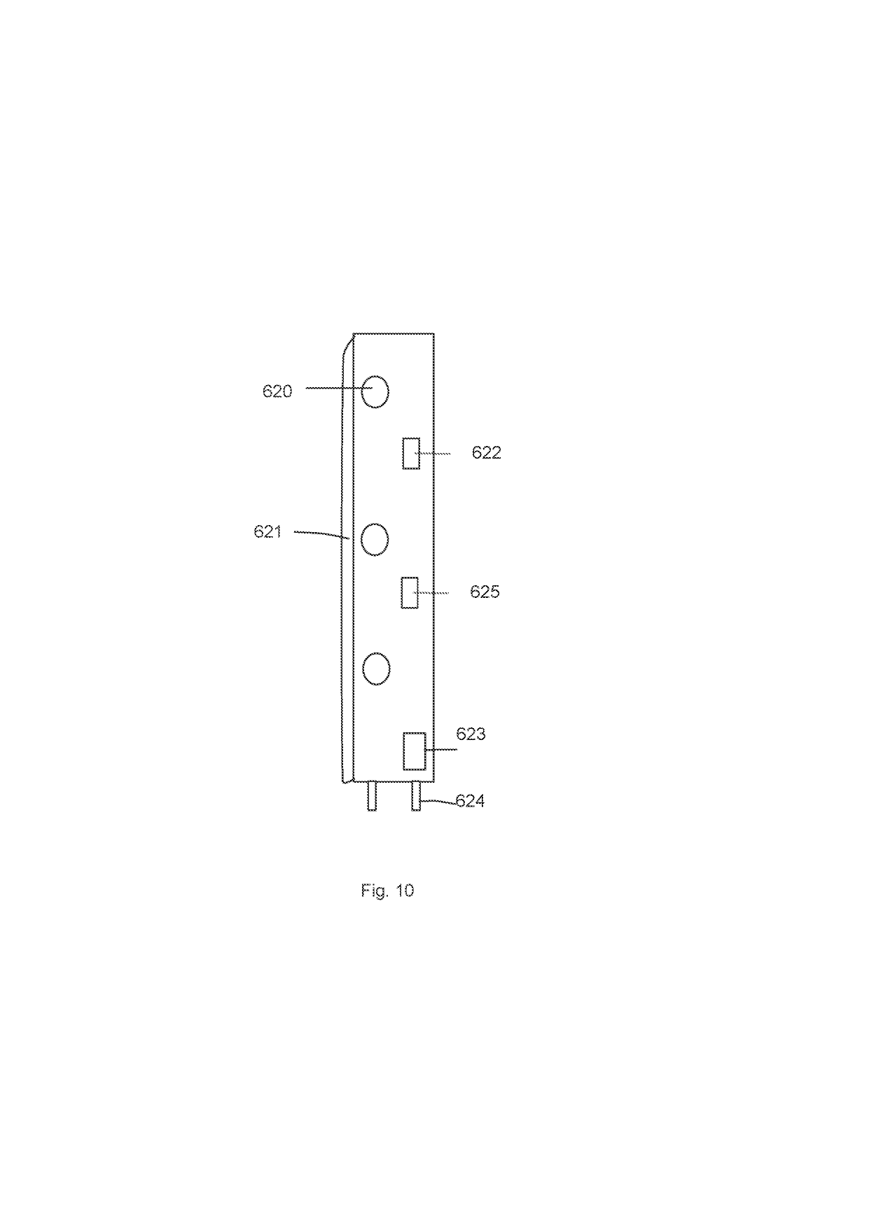

In FIG. 10, a flexible light strip has a LED module 620, a touch sensor 622 and a driver circuit 623. There is a conductive path 621, e.g. metal paths disposed for connecting components.

In some embodiments, a control signal from the touch sensor is transmitted to the driver circuit via a conductive path 621 disposed on the flexible bending light strip.

In some embodiments, the apparatus may also include at least one additional touch sensor 625.

The touch sensor 622 and the at least one additional touch sensor 625 are configured to detect touch events on different portions of the bulb shell.

In some embodiments, the controllable parameters include color temperature.

In some embodiments, the controllable parameters include color.

In some embodiments, the user touch event is associated with a mode change of the light source.

In some embodiments, the mode change switches among multiple modes, each mode having predetermined settings for controlling the plurality of LED modules.

In some embodiments, the mode change is associated with an operating schedule that varies the emitted light according to an internal clock.

In some embodiments, the touch sensor includes a light sensor with a filter configured to detect a specific wavelength of control light.

In some embodiments, the touch sensor includes an infrared (IR) sensor configured to detect an IR remote control signal. FIGS. 8 and 10 show examples where the touch sensors may be disposed. IR sensor can be placed at the positions illustrated in the drawings and is not repeated again.

In some embodiments, the touch sensor includes a light sensor configured to detect motion on the bulb shell.

In some embodiments, the touch sensor is configured to detect static electricity variation on the bulb shell to determine the user touch event.

In FIG. 8, the apparatus may also include an Edison cap 606 configured to couple to an Edison socket 611.

The light source and the support structure are enclosed in a top space 607 defined by the bulb shell 605 and a top boundary of the Edison cap 606.

In some embodiments, the apparatus may also include an electrode structure 608 for guiding input power from the Edison cap to the plurality of LED modules.

A first part of the electrode structure 608 is in the top space and a second part of the electrode structure is enclosed within the Edison cap 606 to engage two electrodes 609, 610 of the Edison cap.

In some embodiments, multiple types of touch sensing circuits are disposed in the light bulb.

Different touch patterns or timings during the user touch event trigger different control signals from the driver circuit.

The present invention relates to a light bulb apparatus designed to provide controllable illumination through integrated touch-sensitive controls. In one embodiment, the light bulb comprises a bulb shell that encloses internal components and allows light to emanate outwardly, typically formed from a translucent or transparent material such as glass or plastic to diffuse or direct the emitted light. Disposed within this bulb shell is a support structure, which serves as a mounting platform for various elements and can be configured in rigid or flexible forms to accommodate different internal layouts. Mounted on this support structure is a light source comprising a plurality of LED modules, each capable of emitting light at specific wavelengths, wherein the controllable parameters of the emitted light, such as color temperature or color, are achieved by adjusting a mixing ratio among the plurality of LED modules through pulse-width modulation or current variation techniques. A touch sensor is disposed on the support structure and configured to detect a user touch event, such as a tap or swipe on the exterior of the bulb shell, which is capacitively or resistively transmitted through the shell material. Operatively coupled to both the touch sensor and the plurality of LED modules is a driver circuit, which receives a signal indicative of the user touch event from the touch sensor and, in response, generates control signals to adjust the mixing ratio, thereby modifying at least one of the controllable parameters of the emitted light, enabling users to intuitively alter lighting characteristics without external switches.

In various implementations, the support structure may comprise a protruding column, extending axially from a base portion toward the apex of the bulb shell, providing structural rigidity and efficient heat dissipation for the LED modules mounted thereon. For example, the protruding column could be fabricated from a thermally conductive material like aluminum or ceramic, with the LED modules arranged circumferentially or linearly along its length to maximize light distribution within the bulb shell. This configuration allows for a compact design suitable for standard bulb form factors, such as A19 or BR30, where the protruding column supports the weight of the LED modules and integrates wiring channels for electrical connections to the driver circuit.

Alternatively, the support structure may comprise a flexible bending light strip, which can be shaped or coiled within the bulb shell to conform to curved or irregular internal spaces, enhancing light uniformity and enabling innovative bulb shapes like filament-style or decorative designs. The flexible bending light strip might include a substrate of polyimide or similar flexible material embedded with conductive traces, upon which the plurality of LED modules are soldered or adhesively attached, allowing the strip to be bent into spirals or loops for omnidirectional illumination. Variations could involve multiple segments of the flexible bending light strip connected in series or parallel, with the driver circuit adapting control signals to account for the strip's flexibility and potential positional variations during manufacturing or use.

In embodiments combining rigid and flexible elements, the light bulb may further comprise a protruding column supporting the flexible bending light strip, wherein the touch sensor is disposed on the protruding column to maintain accessibility and reliability. For instance, the flexible bending light strip could be wound around or attached to the protruding column, which acts as a central spine, while the touch sensor, perhaps a capacitive pad, is positioned on the column's surface to detect touch events transmitted through the bulb shell without interfering with the light strip's flexibility. This hybrid approach facilitates easier assembly, as the protruding column provides a stable anchor point, and allows for variations where the light strip extends beyond the column for extended light coverage.

To enhance user interaction, the light bulb may include at least one additional touch sensor, wherein the touch sensor and the at least one additional touch sensor are configured to detect touch events on different portions of the bulb shell, enabling zoned control. For example, one touch sensor could be oriented toward the lower hemisphere of the bulb shell for brightness adjustments, while another toward the upper for color changes, with the driver circuit processing signals from each independently or in combination. Such multiple sensors could be arrayed along the support structure, calibrated to differentiate touch locations based on signal strength or capacitance changes, supporting implementations in larger bulbs like floodlights where distinct control zones improve usability.

When utilizing a flexible support, the touch sensor may be integrated with the flexible bending light strip, embedding sensor elements directly into the strip's substrate for seamless design and reduced component count. This integration could involve printing capacitive electrodes onto the light strip alongside the LED modules, allowing the entire assembly to flex without compromising touch detection. Variations might include waterproof coatings over the integrated sensor to protect against environmental factors, or modular designs where sections of the light strip dedicate specific areas to sensing versus illumination.

In such integrated configurations, a control signal from the touch sensor may be transmitted to the driver circuit via a conductive path disposed on the flexible bending light strip, minimizing wiring clutter and enhancing reliability. The conductive path could comprise etched copper traces or flexible printed circuits running parallel to the power lines for the LED modules, with signal isolation to prevent interference. For example, in a coiled light strip, the conductive path might spiral along the strip's length, carrying analog or digital signals that the driver circuit interprets to adjust LED outputs, supporting variations like multiplexed paths for multiple sensors.

Among the controllable parameters, the light parameters may specifically include color temperature, adjustable from warm (e.g., 2700K) to cool (e.g., 6500K) tones by varying the mixing ratio of warm-white and cool-white LED modules. This enables applications in circadian rhythm lighting, where the driver circuit modulates outputs based on touch inputs to simulate natural daylight progression. Examples include preset modes for reading (higher color temperature) or relaxation (lower), with the touch sensor triggering incremental adjustments.

Similarly, the controllable parameters may include color, achieved by incorporating red, green, blue (RGB) or additional LED modules like amber, allowing full-spectrum color mixing via the driver circuit's control signals. Users could cycle through colors with successive touches, for decorative purposes in holiday lighting or mood settings, with variations incorporating color wheel algorithms in the driver circuit for smooth transitions.

The user touch event may be associated with a mode change of the light source, where a detected touch prompts the driver circuit to switch operational states beyond simple on/off. For instance, a double-tap could activate a dimming mode, while a hold could initiate color cycling, with the driver circuit storing mode states in non-volatile memory for persistence across power cycles.

In further detail, the mode change may switch among multiple modes, each mode having predetermined settings for controlling the plurality of LED modules, such as a "nightlight" mode with low-intensity amber light or a "party" mode with dynamic color shifts. These settings could be factory-programmed or user-customizable via repeated touch sequences, enabling the light bulb to adapt to various environments like bedrooms or entertainment spaces.

Additionally, the mode change may be associated with an operating schedule that varies the emitted light according to an internal clock, integrated into the driver circuit with a real-time clock module. For example, upon touch activation, the schedule could gradually dim the light over 30 minutes to aid sleep, or ramp up brightness at dawn, with variations syncing to external time via initial setup touches.

The touch sensor may comprise a light sensor with a filter configured to detect a specific wavelength of control light, expanding "touch" to include optical inputs like laser pointers or smartphone flashes at designated wavelengths. This allows non-contact control, where the filter (e.g., bandpass for 650nm red) isolates the control signal from ambient light, triggering the driver circuit accordingly.

Furthermore, the touch sensor may comprise an infrared (IR) sensor configured to detect an IR remote control signal, compatible with standard remotes for broader integration. The IR sensor could be embedded in the support structure, decoding protocols like NEC to interpret commands, with the driver circuit translating them into LED adjustments, supporting hybrid touch/remote operation.

The touch sensor may also comprise a light sensor configured to detect motion on the bulb shell, using photodetectors to sense shadows or gestures cast by a user's hand near the shell. This enables gesture-based controls, such as waving to toggle modes, with signal processing in the driver circuit to differentiate intentional motions from environmental changes.

In capacitive embodiments, the touch sensor may be configured to detect static electricity variation on the bulb shell to determine the user touch event, leveraging the shell as a dielectric medium. Variations in charge induced by finger proximity alter capacitance, which the sensor measures and relays to the driver circuit, suitable for frosted shells where direct contact is diffused.

When employing a columnar support, the touch sensor may be disposed on a top of the protruding column, positioning it near the bulb's apex for optimal sensitivity to touches on the upper shell. This placement aids in heat management, as the top is cooler, and allows for antenna-like extensions in variations for enhanced signal pickup.

The light bulb may further comprise an Edison cap configured to couple to an Edison socket, providing standard electrical interfacing, wherein the light source and the support structure are enclosed in a top space defined by the bulb shell and the Edison cap. This enclosure protects internals from dust and moisture, with the Edison cap including threaded metal for AC power input, supporting E26 or E27 standards.

Additionally, an electrode structure may guide input power from the Edison cap to the plurality of LED modules, wherein a first part of the electrode structure is in the top space (e.g., wires or bus bars connecting to the support) and a second part is enclosed within the Edison cap (e.g., insulated contacts). This bifurcation ensures safety and efficiency, with variations using PCB traces for the top part to integrate with the driver circuit.

Multiple types of touch sensing circuits may be disposed in the light bulb, such as combining capacitive, optical, and IR methods, wherein different touch patterns or timings during the user touch event trigger different control signals from the driver circuit. For example, a short tap might adjust brightness, a long hold color, or a swipe sequence activate schedules, with the driver circuit employing pattern recognition algorithms to discern inputs, enabling rich, multifaceted control in a single device.

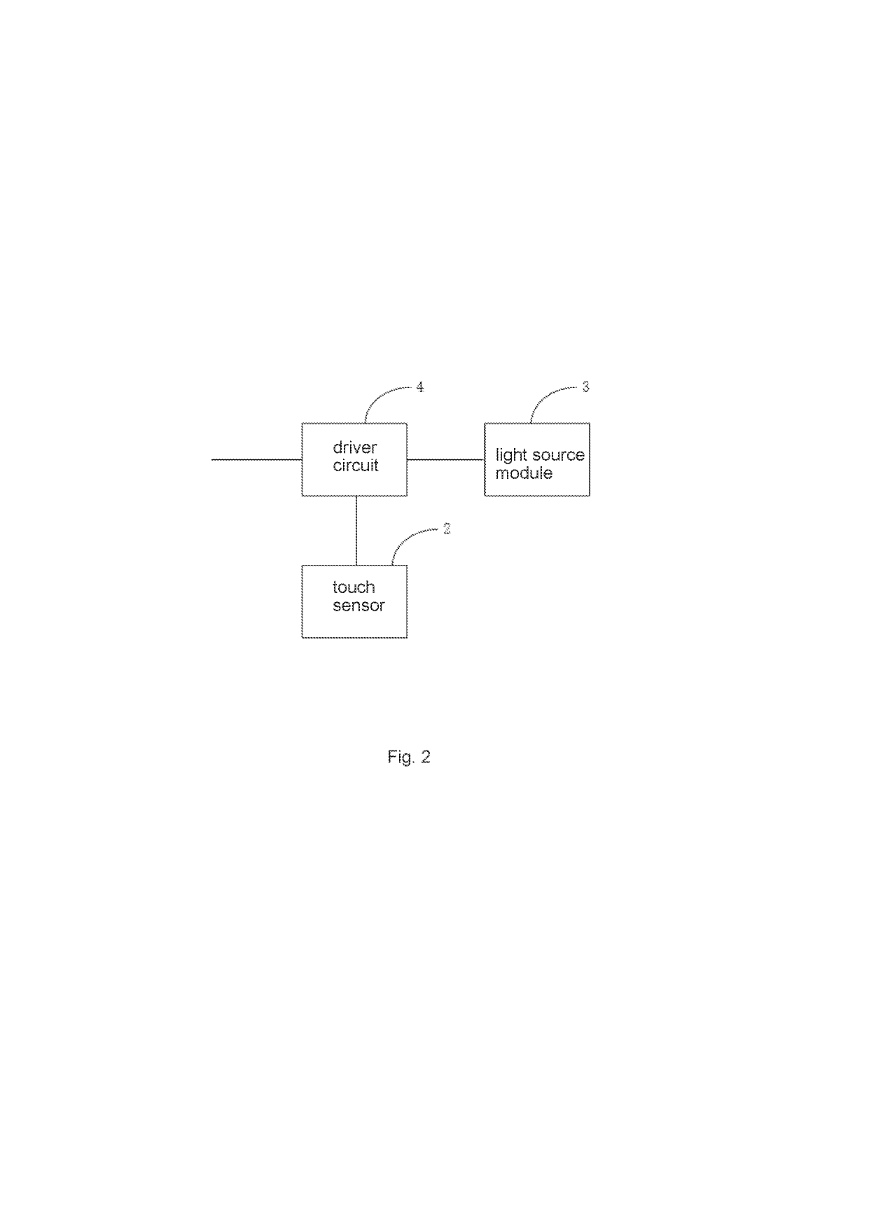

FIG. 1 is a structural schematic diagram of a touch lamp provided in an embodiment; FIG. 2 is a circuit structural schematic diagram of a touch lamp provided in an embodiment. Referring to FIGS. 1 and 2, the touch lamp comprises: a lampshade 1, a touch sensor 2, a light source module 3, and a driver circuit 4. The light source module 3, the touch sensor 2, and the driver circuit 4 are all disposed inside the lampshade 1.

The input end of the driver circuit 4 is configured to be connected to a power supply, the control end of the driver circuit 4 is connected to the output end of the touch sensor 2, and the output end of the driver circuit 4 is connected to the light source module 3.

The touch sensor 2 is in contact with the lampshade 1. The touch sensor 2 acquires a touch action from outside the lampshade 1 and sends a touch signal to the driver circuit 4 to adjust the light source module 3.

Referring to FIGS. 1 and 2, in this embodiment, the touch sensor 2 is provided to acquire a user’s touch action, generate a touch signal, and the driver circuit 4 adjusts the brightness of the light source module 3 according to the touch signal. This achieves dimming without redundant mechanical structures or external tools, thereby simplifying operation and making control more convenient. At the same time, no physical structural design is required on the lamp body surface, maintaining consistency and integrity of the lamp body structure. Moreover, the overall circuit cost is low, greatly reducing the cost of the touch lamp and benefiting product manufacturing efficiency.

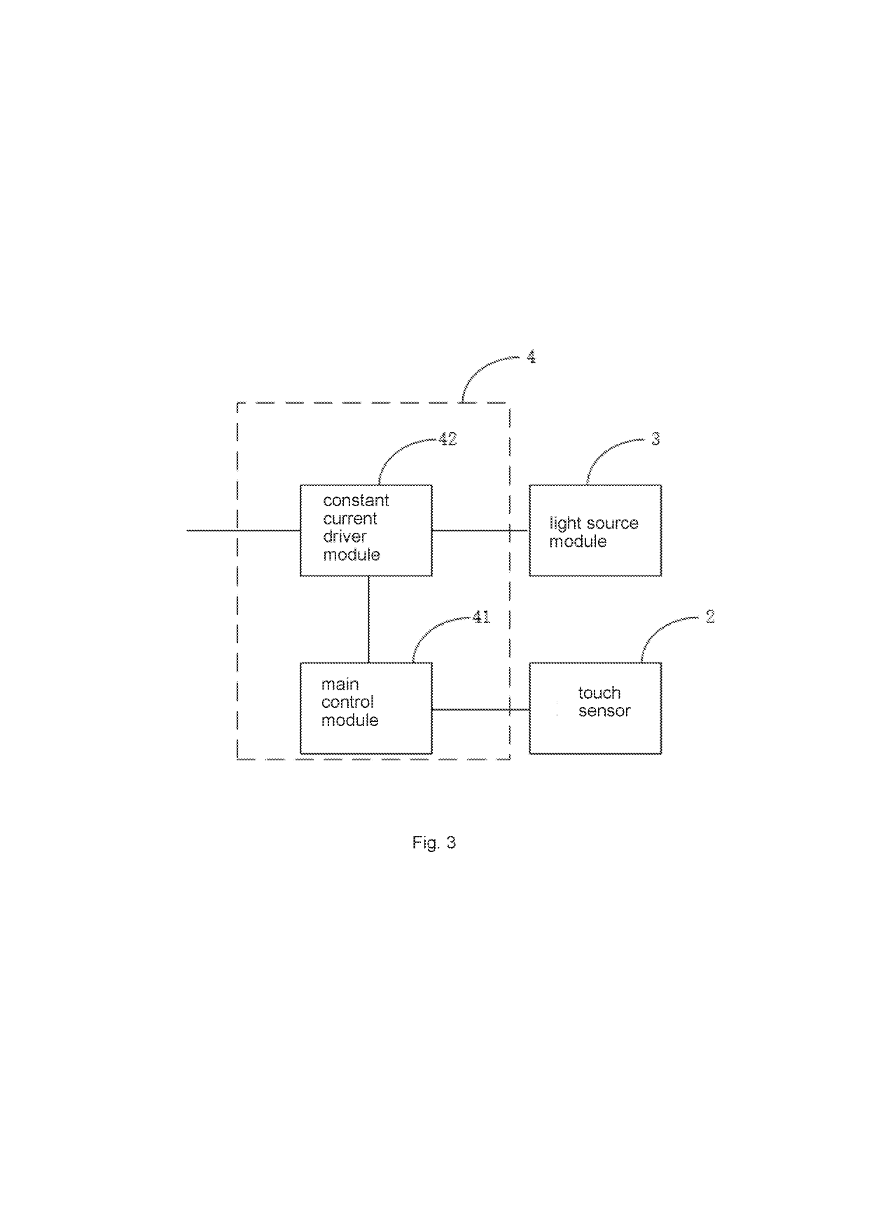

In one possible embodiment, referring to FIG. 3, the driver circuit 4 may comprise: a main control module 41 and a constant current driver module 42.

The input end of the main control module 41 forms the control end of the driver circuit 4, and the output end of the main control module 41 is connected to the control end of the constant current driver module 42.

The input end of the constant current driver module 42 forms the input end of the driver circuit 4, and the output end of the constant current driver module 42 forms the output end of the driver circuit 4.

The main control module 41 is configured to receive a touch signal and, according to the touch signal, control the constant current driver module 42 to realize dimming.

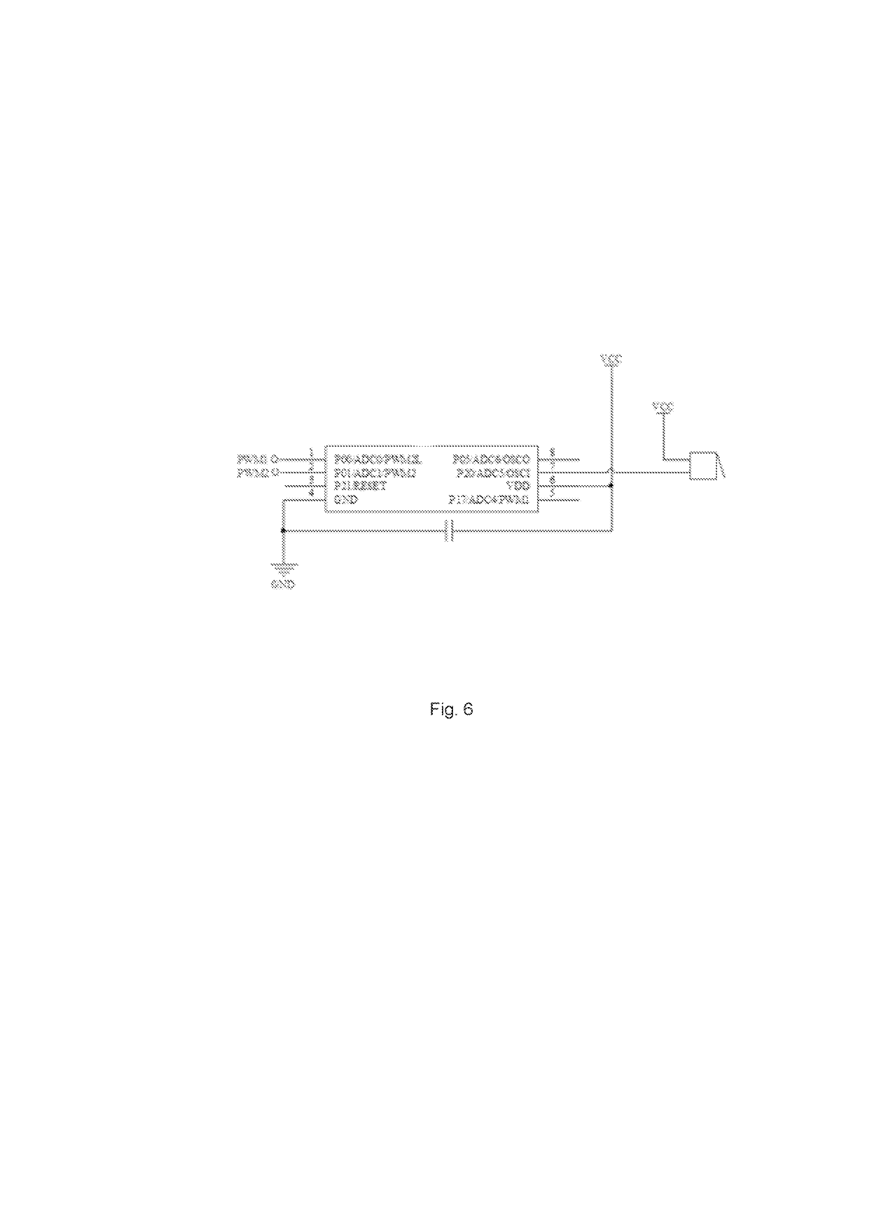

Exemplarily, the main control module 41 may comprise a microcontroller. The peripheral circuit and specific circuit principle of the microcontroller may refer to FIG. 6, and will not be further described herein.

The microcontroller has built-in touch logic. The microcontroller controls the constant current driver module 42 according to the received touch signal to output different power, brightness, and color temperature of light. It should be noted that the touch logic may be set according to actual application requirements, which belongs to conventional technical means in the art. The present application protects only the hardware, and the above control logic is not within the protection scope of the present application.

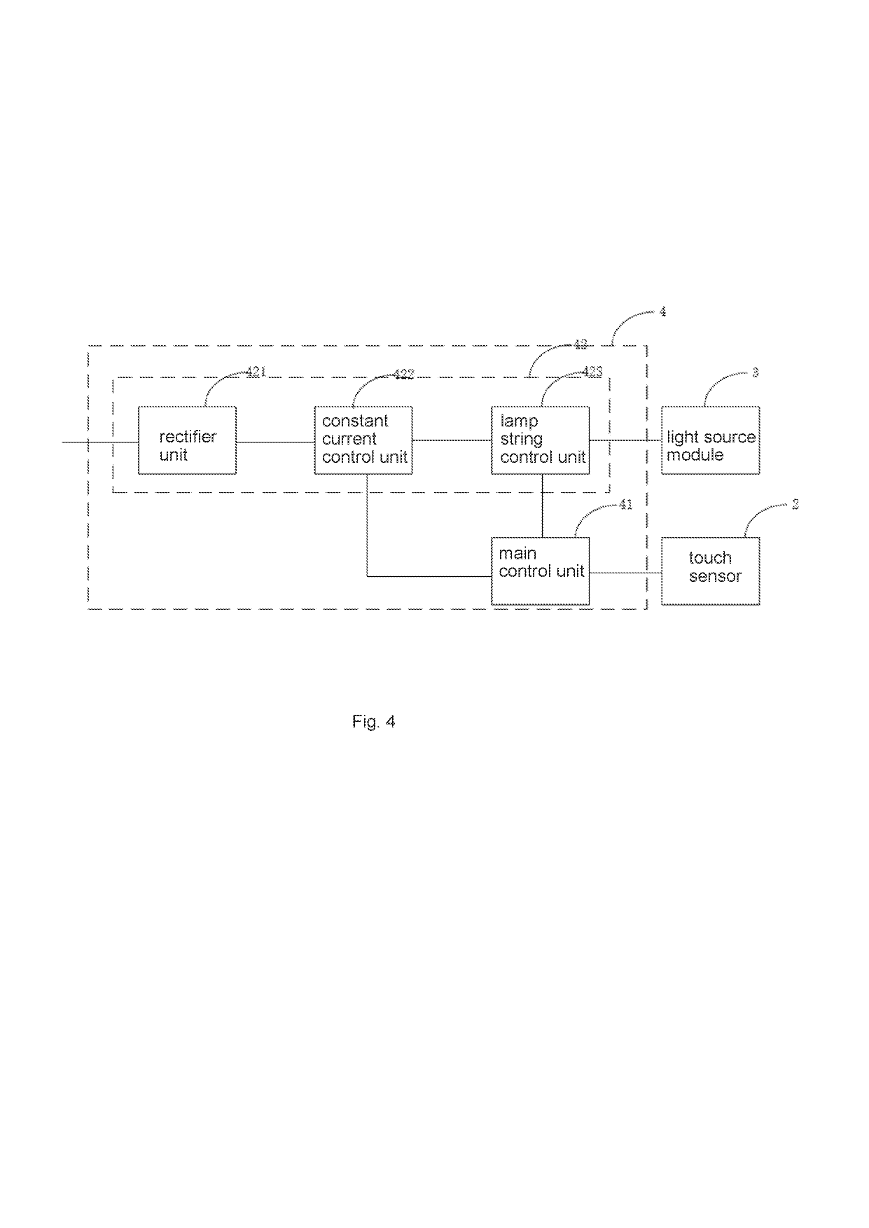

In one possible embodiment, referring to FIG. 4, the light source module 3 comprises at least two LED lamp strings. The output end of the main control module 41 comprises a first output end and a second output end. The control end of the constant current driver module 42 comprises a first control end and a second control end. The first output end is connected to the first control end, and the second output end is connected to the second control end. The constant current driver module 42 comprises: a rectifier unit 421, a constant current control unit 422, and a lamp string control unit 423.

The input end of the rectifier unit 421 forms the input end of the constant current driver module 42, and the output end of the rectifier unit 421 is connected to the input end of the constant current control unit 422.

The output end of the constant current control unit 422 is connected to the input end of the lamp string control unit 423, and the control end of the constant current control unit 422 forms the first control end.

The control end of the lamp string control unit 423 forms the second control end, and the output end of the lamp string control unit 423 forms the output end of the constant current driver module 42.

Referring to FIG. 4, the power supply may be an AC power supply. The rectifier unit 421 is used to rectify the AC power supply. The constant current control unit 422 is used to regulate the power to achieve brightness adjustment of the touch lamp. The lamp string control unit 423 is used to regulate the current of different lamp strings to achieve color temperature adjustment of the touch lamp.

The main control module 41 generates two dimming signals (a first dimming signal PWM1 and a second dimming signal PWM2) based on the touch signal acquired by the touch sensor 2, and respectively sends them to the constant current control unit 422 and the lamp string control unit 423, thereby respectively realizing brightness and color temperature adjustment.

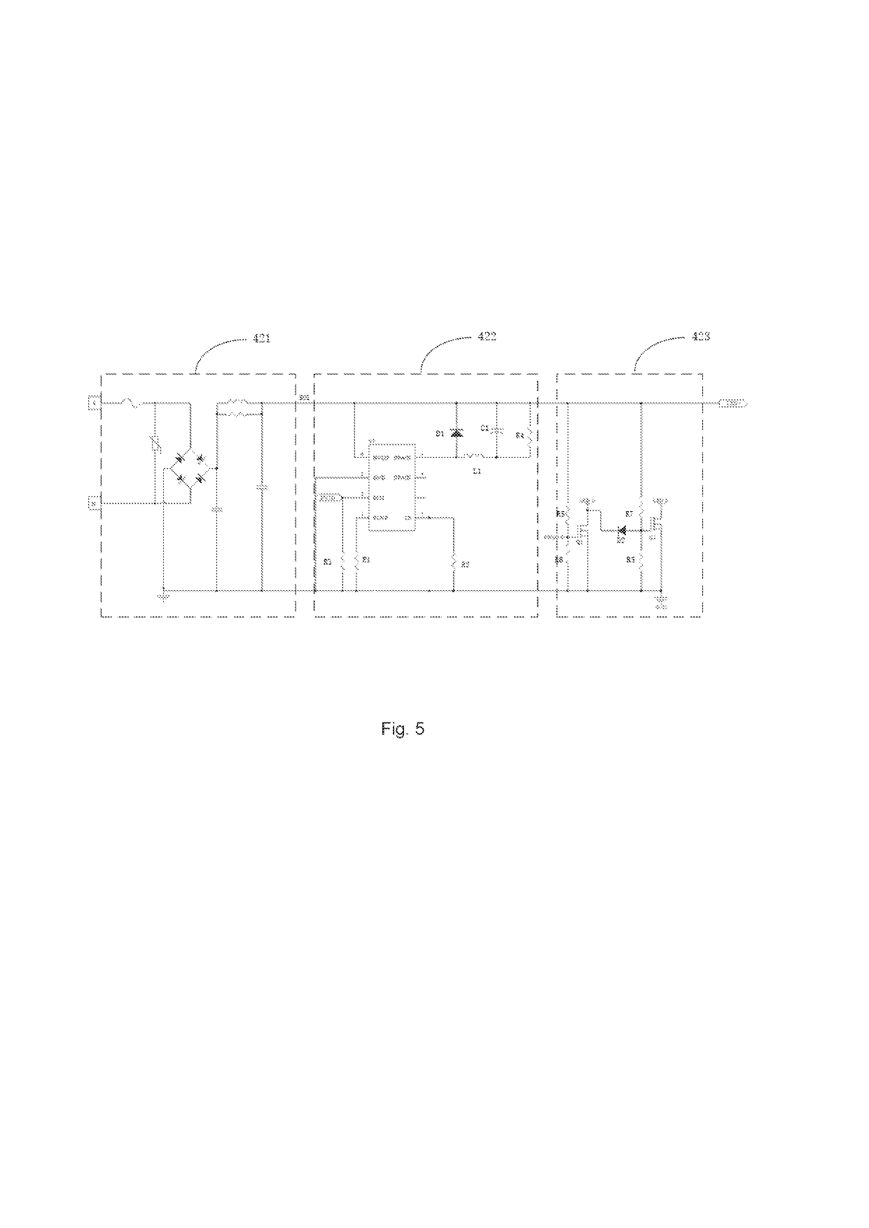

In one possible embodiment, referring to FIG. 5, the constant current control unit 422 may comprise: a constant current control chip U1, a first diode D1, a first inductor L1, a first capacitor C1, a first resistor R1, a second resistor R2, a third resistor R3, and a fourth resistor R4.

The power pin (pin 4) of the constant current control chip U1 forms the input end of the constant current control unit 422. The drive pin (pin 5) is connected to the anode of the first diode D1 and the first end of the first inductor L1. The over-voltage protection pin (pin 1) is grounded through the first resistor R1. The current sensing pin (pin 7) is grounded through the second resistor R2. The PWM dimming pin (pin 2) forms the control end of the constant current control unit 422 and is further grounded through the third resistor R3.

The cathode of the first diode D1 is connected to the power pin of the constant current control chip U1, the first end of the first capacitor C1, and the first end of the fourth resistor R4. The cathode of the first diode D1 also forms the output end of the constant current control unit 422.

The second end of the first inductor L1 is connected to the second end of the first capacitor C1 and the second end of the fourth resistor R4.

Referring to FIG. 5, the constant current control chip U1 receives the first dimming signal PWM1 sent by the main control module 41 and adjusts the total current (i.e., power) output by the constant current control unit 422 to achieve brightness adjustment. The detailed circuit of the constant current control unit 422 will not be further described herein, and may refer to FIG. 5.

It should be noted that both the first dimming signal PWM1 and the second dimming signal PWM2 may be PWM signals.

In one possible embodiment, referring to FIG. 5, the light source module 3 may comprise: a first LED lamp string and a second LED lamp string. The lamp string control unit 423 may comprise: a first switching transistor Q1, a second switching transistor Q2, a second diode D2, a fifth resistor R5, a sixth resistor R6, a seventh resistor R7, and an eighth resistor R8.

The first end of the first switching transistor Q1 is connected to the cathode of the second diode D2 and the negative electrode of the first LED lamp string. The second end of the first switching transistor Q1 is grounded. The control end of the first switching transistor Q1 is connected to the first ends of the fifth resistor R5 and the sixth resistor R6. The control end of the first switching transistor Q1 also forms the control end of the lamp string control unit 423.

The first end of the second switching transistor Q2 is connected to the negative electrode of the second LED lamp string. The second end of the second switching transistor Q2 is grounded. The control end of the second switching transistor Q2 is connected to the first ends of the seventh resistor R7 and the eighth resistor R8 and to the anode of the second diode D2.

The second end of the fifth resistor R5 is connected to the second end of the seventh resistor R7, the positive electrode of the first LED lamp string, and the positive electrode of the second LED lamp string. The second end of the fifth resistor R5 also forms the output end and the input end of the lamp string control unit 423.

The second ends of the sixth resistor R6 and the eighth resistor R8 are both grounded.

Referring to FIG. 5, the light source module 3 comprises two LED lamp strings, namely the first LED lamp string and the second LED lamp string. The lamp string control unit 423 receives the second dimming signal PWM2, which is a PWM signal. When the second dimming signal is at a high level, the first switching transistor Q1 is turned on, the first LED lamp string emits light, the second switching transistor Q2 is turned off, and the second LED lamp string does not emit light. When the second dimming signal is at a low level, the first switching transistor Q1 is turned off, the first LED lamp string does not emit light, the second switching transistor Q2 is turned on, and the second LED lamp string emits light. Thus, by adjusting the duty cycle of the second dimming signal PWM2, color temperature adjustment can be realized.

Exemplarily, the first switching transistor Q1 and the second switching transistor Q2 may both be NMOS transistors.

In one possible embodiment, the touch sensor 2 may comprise a metal conducting wire.

The first end of the metal conducting wire forms the output end of the touch sensor 2, and the second end of the metal conducting wire is connected to a DC power supply VCC. The metal conducting wire is in contact with the lampshade 1 between its first and second ends.

In this embodiment, dimming can be achieved by acquiring a user’s touch action through the metal conducting wire. The touch sensor 2 is not limited to comprising a metal conducting wire but may also comprise other elements, which are not further limited herein.

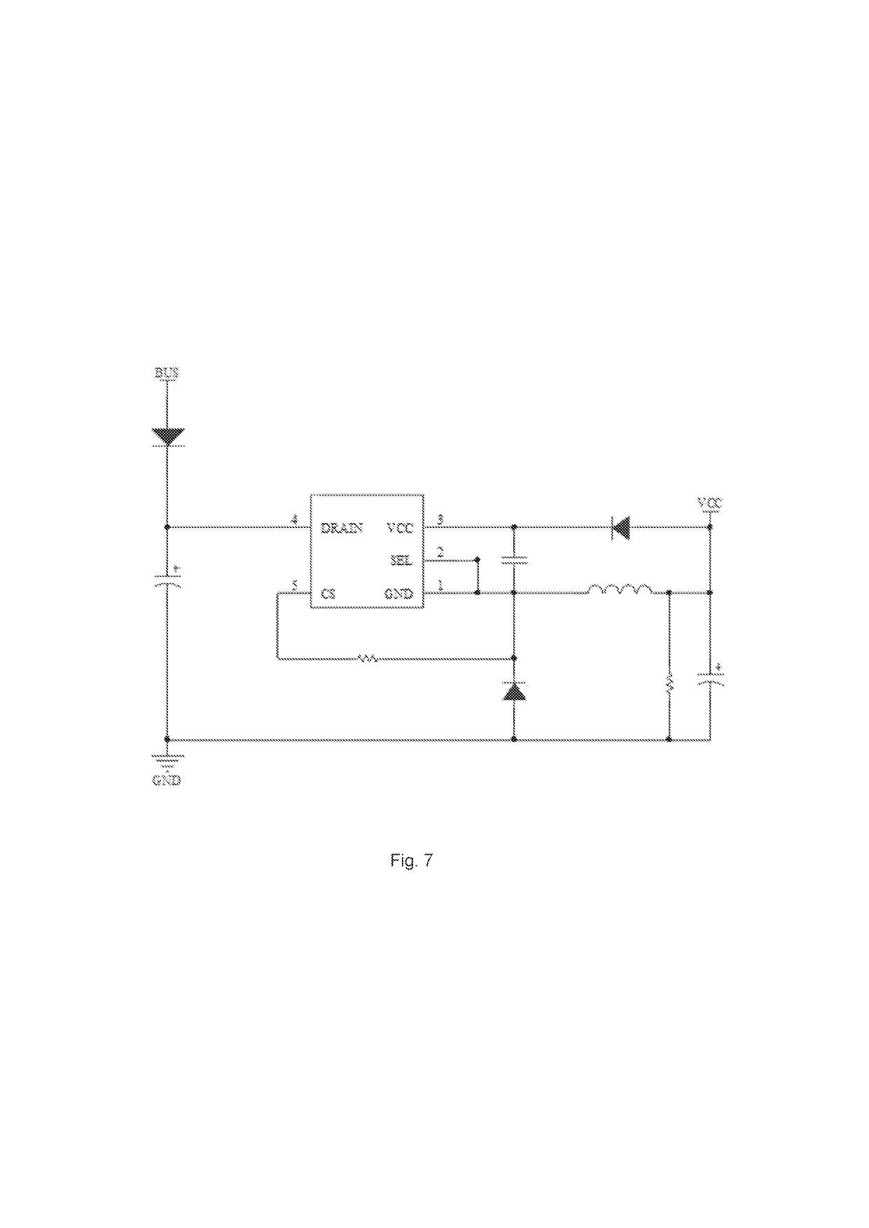

In one possible embodiment, referring to FIG. 7, the touch lamp may further comprise an auxiliary power supply module.

The input end of the auxiliary power supply module is connected to the output end of the rectifier unit 421, and the output end of the auxiliary power supply module outputs a DC power supply VCC.

In this embodiment, the auxiliary power supply module may also be provided to supply DC power to the touch sensor 2.

The circuit principle diagram of the auxiliary power supply module may refer to FIG. 7. This belongs to conventional technical means in the art and will not be further described herein. At the same time, referring to FIG. 6, the auxiliary power supply module may also supply power to the microcontroller.

Exemplarily, the rectifier unit 421 may comprise a rectifier bridge, and filtering is also provided. The specific circuit may refer to FIG. 5, which belongs to conventional technical means in the art and will not be further described herein.

In one possible embodiment, referring to FIG. 1, the touch lamp may further comprise an Edison cap 5 and a pin 6.

The Edison cap 5 is sleeved on the lampshade 1. The pin 6 passes through the Edison cap 5 and extends into the interior of the Edison cap 5 to be electrically connected to the input end of the driver circuit 4.

The power supply provides power to the driver circuit 4 through the pin 6.

Referring to FIG. 1, the touch lamp further comprises the Edison cap 5 and the pin 6. The Edison cap 5 is provided with threads. The touch lamp may be connected to a power supply base through the Edison cap 5. The power supply base contacts the pin 6, and the driver circuit 4 is powered through the pin 6.

Also referring to FIG. 1, the touch sensor 2 passes through the light source module 3 to connect to the driver circuit 4 without affecting normal light emission of the light source module 3, thereby avoiding blocking of the light from the light source module 3.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A light bulb, comprising:
a bulb shell;
a support structure disposed within the bulb shell;
a light source comprising a plurality of LED modules mounted on the support structure, the plurality of LED modules configured to emit light having controllable parameters including at least one of color temperature or color by adjusting a mixing ratio among the plurality of LED modules;
a touch sensor disposed on the support structure and configured to detect a user touch event; and
a driver circuit operatively coupled to the touch sensor and the plurality of LED modules, the driver circuit configured to receive a signal indicative of the user touch event from the touch sensor and, in response thereto, generate control signals to adjust the mixing ratio among the plurality of LED modules, thereby modifying at least one of the controllable parameters of the emitted light.

2. The apparatus of claim 1, wherein the support structure comprises a protruding column.

3. The apparatus of claim 2, wherein the touch sensor is disposed on a top of the protruding column.

4. The apparatus of claim 1, wherein the support structure comprises a flexible bending light strip.

5. The apparatus of claim 4, further comprising a protruding column supporting the flexible bending light strip, wherein the touch sensor is disposed on the protruding column.

6. The apparatus of claim 4, wherein the touch sensor is integrated with the flexible bending light strip.

7. The apparatus of claim 6, wherein a control signal from the touch sensor is transmitted to the driver circuit via a conductive path disposed on the flexible bending light strip.

8. The apparatus of claim 1, further comprising at least one additional touch sensor, wherein the touch sensor and the at least one additional touch sensor are configured to detect touch events on different portions of the bulb shell.

9. The apparatus of claim 1, wherein the controllable parameters include color temperature.

10. The apparatus of claim 1, wherein the controllable parameters include color.

11. The apparatus of claim 1, wherein the user touch event is associated with a mode change of the light source.

12. The apparatus of claim 11, wherein the mode change switches among multiple modes, each mode having predetermined settings for controlling the plurality of LED modules.

13. The apparatus of claim 11, wherein the mode change is associated with an operating schedule that varies the emitted light according to an internal clock.

14. The apparatus of claim 1, wherein the touch sensor comprises a light sensor with a filter configured to detect a specific wavelength of control light.

15. The apparatus of claim 1, wherein the touch sensor comprises an infrared (IR) sensor configured to detect an IR remote control signal.

16. The apparatus of claim 1, wherein the touch sensor comprises a light sensor configured to detect motion on the bulb shell.

17. The apparatus of claim 1, wherein the touch sensor is configured to detect static electricity variation on the bulb shell to determine the user touch event.

18. The apparatus of claim 1, further comprising an Edison cap configured to couple to an Edison socket, wherein the light source and the support structure are enclosed in a top space defined by the bulb shell and the Edison cap.

19. The apparatus of claim 18, further comprising an electrode structure for guiding input power from the Edison cap to the plurality of LED modules, wherein a first part of the electrode structure is in the top space and a second part of the electrode structure is enclosed within the Edison cap.

20. The apparatus of claim 1, wherein multiple types of touch sensing circuits are disposed in the light bulb, and wherein different touch patterns or timings during the user touch event trigger different control signals from the driver circuit.
